(19) United States
(12) Patent Application Publication
(10) Pub. No.: US 2024/0330822 A1
(43) Pub. Date: Oct. 3, 2024

(54) COMPUTER IMPLEMENTED BUSINESS MANAGEMENT SYSTEM AND METHOD FOR AN ORGANIZATION

(71) Applicant: Sky Sterling Inc., Henderson, NV (US)

(72) Inventor: John T. Rankins, Henderson, NV (US)

(21) Appl. No.: 18/128,434

(22) Filed: Mar. 30, 2023

(51) Int. Cl. G06Q 10/0637; G06Q 10/0639; G06Q 30/0208

(52) U.S. Cl. CPC G06Q 10/0637; G06Q 10/06393; G06Q 10/06398; G06Q 30/0208

(57) ABSTRACT

A computer implemented business management system and method are provided for an organization. The system includes at least a processor, a memory unit, a business management platform, and a plurality of network-connected computer user interfaces for a plurality of participants. Herein, the participants include owners, a plurality of actual or potential team members, respective team managers and customers. Furthermore, the business management platform comprises a marketing and sales management module, a learning management module, a customer engagement module and a performance management module integrated with the marketing and sales management module, the learning management module, and the customer engagement module.

### FIELD OF THE INVENTION

The present application relates to systems and applications designed to support, manage, and automate business functions. More particularly, the present application relates to computer implemented business management system and method for an organization. The present invention is designed to help businesses grow by making sure that all parts of the business organization are working efficiently. The presented solution is made to be a driver and enabler of teams and individuals by allowing the organizations to easily manage, track, align and reward their Sales, Marketing, Customer Engagement, and Personnel Development Teams using one Integrated Platform.

### BACKGROUND OF THE INVENTION

Sales, Marketing, Customer Engagement, and People Development are the four main disciplines (or Key Result Areas) of any organization that, when managed poorly, will surely drive them down to the ground statistics show. Based on our research, following observations have been made:

### Sales

80% of sales are made by 20% of salespeople. The winners sell to the prospects the losers give up on.
Top sales pros outperform low performers by 10:1 and average ones by 2:1.
Turnover for the average sales team is about 34%. The involuntary turnover percentage is at 66%.

### Marketing

Failure to align sales and marketing teams around the right processes/technology costs B2B companies 10% or more of revenue per year ($100 million for a billion-dollar company).
85% of marketing teams say supporting their sales team is their #1 priority. Still, 56% of salespeople must prepare their own sales materials.
Companies that excel at lead nurturing generate 50% more sales-ready leads at 33% lower cost.

### Engagement

Acquiring a new customer costs 5-25 times more than keeping an existing customer.
U.S. sales teams spend over $70 billion a year on training. It's 80% forgotten in 3 months.
90% of all buying decisions rely on peer recommendations.

### Personnel Development

24% higher profit margins can be the result of companies who invest in training.
40% of employees with poor training will leave the company within the first year.
$500 billion is lost every year due to employee disengagement. Disengaged employees don't work as hard as those who are committed to your company.

To overcome the above challenges, the subject application proposes a computer implemented business management system and method for an organization. Such a solution should help businesses grow by making sure that all parts of the business organization are working efficiently, and should act as a driver and enabler of teams and individuals by allowing the organizations to easily manage, track, align and reward their Sales, Marketing, Customer Engagement, and Personnel Development Teams in one Integrated Platform.

The present application is described hereinafter by various embodiments. This application may, however, be embodied in many different forms and should not be construed as limited to the embodiment set forth herein.

### SUMMARY OF THE INVENTION

According to a first aspect of the present invention, there is provided a computer implemented business management system for an organization. The system comprises, but not limited to, at least a processor, a memory unit, a business management platform, and a plurality of network-connected computer user interfaces for a plurality of participants. Herein, said participants comprise, but not limited to, owners, a plurality of actual or potential team members, respective team managers and customers. Further, the business management platform comprises, but not limited to, a marketing and sales management module configured to facilitate lead generation, lead management, deal management, and deal fulfillment: a learning management module configured to facilitate course creation, course Assessment, course Consumption and course metrics for development of the plurality of participants by training the teams and the individual team members based on the respective roles and requirements of the organization: a customer engagement module configured to facilitate customer relationship management, customer retention, ticket management and help & support; and a performance management module integrated with the marketing and sales management module, the learning management module, and the customer engagement module. Furthermore, the performance management module is configured to manage, track, align and reward the plurality of participants, by creating goals for teams/individuals based on Key-Result-Area (KRA) metrics: tracking goals of teams/individual participants and awarding badges for successful goal delivery: creating levels of development for team members based on badges earned when successfully meeting or exceeding goals: retrieving performance metrics from Sales and Marketing management module, Learning Management, and Customer Engagement module of the platform; and providing customized dashboards based on roles of the plurality of participants to enhance their performance, thereby allowing the organization to easily manage, track, align and reward their sales, marketing, customer engagement, and people development teams in one Integrated Platform.

In accordance with an embodiment of the present invention, the lead generation and lead management includes, but not limited to, importing leads/contacts from third party and spreadsheets, enabling Call/SMS, Email Leads/Contacts worldwide directly from the list, integrating the email and creating campaigns with built-in analytics, integrating messaging apps, tracking and logging all communications, and on-the-fly tagging of leads/contacts for faster searching, filtering, and sorting.

In accordance with an embodiment of the present invention, the deal management includes, but not limited to, deal tracking and automatic relationship of Accounts, Contacts, Tasks, Calls, Meetings, To-do's, Quotes, invoices, automatic reminder/notification of important Deal events, provide a direct interface to a full-suite Inventory, Quote, and an Invoice Management system.

In accordance with an embodiment of the present invention, the course management includes, but not limited to, creating training programs based on topics important to the organization, assigning courses to teams/individual participants, providing interactive training multimedia content, creating assessment tests at the end of a training program, and issuing certificates and/or badges for the completed training programs or courses.

In accordance with an embodiment of the present invention, the ticket management includes providing an information-at-a-glance user interface that allows to create tickets from phone, chat, email, and social media, shows custom ticket properties and pick lists, shows ticket and support activity history/logs and is also integrated to Communication Solutions and the marketing & sales management module of the platform.

In accordance with an embodiment of the present invention, the learning management module is further configured to facilitate psychometric assessments of a plurality of actual or potential team members, and respective team managers to assess the respective intelligence, abilities, potential and personality.

In accordance with an embodiment of the present invention, the performance management module is further configured to facilitate gamification of the goal creation, tracking, alignment and rewards in a form of challenges, battles and duels to promote competition and growth.

In accordance with an embodiment of the present invention, the rewards are provided in a form of redeemable reward points, offers or coupons.

In accordance with an embodiment of the present invention, the business management platform further comprises a role management module, a team management module, a tasks management module, a notes management module, a calendar management module, an email management module and a communications management module.

In accordance with an embodiment of the present invention, the network-connected computer user interfaces are selected from Desktop PCs, laptops, tablets and mobile phone.

According to a second aspect of the present invention, there is provided a computer implemented business management method for an organization. The method comprises, but not limited to, providing a business management platform, and a plurality of network-connected computer user interfaces for a plurality of participants connected on the business management platform, said participants comprising owners, a plurality of actual or potential team members, respective team managers and customers: providing a marketing and sales management module configured to facilitate lead generation, lead management, deal management, and deal fulfillment: providing a learning management module configured to facilitate course creation, course assessment, course Consumption and course metrics for development of the plurality of participants by training the teams and the individual team members based on the respective roles and requirements of the organization: providing a customer engagement module configured to facilitate customer relationship management, customer retention, ticket management and help & support; and providing a performance management module integrated with the marketing and sales management module, the learning management module, and the customer engagement module. Further, the performance management module is configured to manage, track, align and reward the plurality of participants, by creating goals for teams/individuals based on Key-Result-Area (KRA) metrics: tracking goals of teams/individual participants and awarding badges for successful goal delivery: creating levels of development for team members based on badges earned when successfully meeting or exceeding goals: retrieving performance metrics from Sales and Marketing management module, Learning Management, and Customer Engagement module of the platform; and providing customized dashboards based on roles of the plurality of participants to enhance their performance, thereby allowing the organization to easily manage, track, align and reward their sales, marketing, customer engagement, and people development teams in one Integrated Platform.

In accordance with an embodiment of the present invention, the steps of lead generation and lead management in the marketing and sales management module includes importing leads/contacts from third party and spreadsheets, enabling Call/SMS, Email Leads/Contacts worldwide directly from the list, integrating the email and creating campaigns with built-in analytics, integrating messaging apps, tracking and logging all communications. and on-the-fly tagging of leads/contacts for faster searching, filtering, and sorting.

In accordance with an embodiment of the present invention, the step of the deal management in the marketing and sales management module includes deal tracking and automatic relationship of Accounts, Contacts, Tasks, Calls, Meetings, To-do's, Quotes, invoices, automatic reminder/notification of important Deal events, provide a direct interface to a full-suite Inventory, Quote, and an Invoice Management system.

In accordance with an embodiment of the present invention, the step of the course management in the learning management module includes creating training programs based on topics important to the organization, assigning courses to teams/individual participants, providing interactive training multimedia content, creating assessment tests at the end of a training program, and issuing certificates and/or badges for the completed training programs or courses.

In accordance with an embodiment of the present invention, the step of ticket management in the customer engagement module includes providing an information-at-a-glance user interface that allows to create tickets from phone, chat, email, and social media, shows custom ticket properties and pick lists, shows ticket and support activity history/logs and is also integrated to Communication Solutions and the marketing & sales module of the platform.

In accordance with an embodiment of the present invention, the method further comprises a step of gamification of the goal creation, tracking, alignment and rewards in a form of challenges, battles and duels to promote competition and growth.

In accordance with an embodiment of the present invention, the method further comprises a step of conducting psychometric assessments of a plurality of actual or potential team members, and respective team managers to assess the respective intelligence, abilities, potential and personality.

In accordance with an embodiment of the present invention, the rewards are provided in a form of redeemable reward points, offers or coupons.

In accordance with an embodiment of the present invention, the method further comprises steps of providing a role management module, a team management module, a tasks management module, a notes management module, a calendar management module, an email management module and a communications management module in the business management platform.

In accordance with an embodiment of the present invention, the network-connected computer user interfaces are selected from Desktop PCs, laptops, tablets and mobile phone.

### BRIEF DESCRIPTION OF THE DRAWINGS

The accompanying Figures (Figs.) illustrate embodiments and serve to explain principles of the disclosed embodiments. It is to be understood, however, that these Figures are presented for purposes of illustration only, and not for defining limits of relevant applications. It is to be noted, however, that the appended drawings illustrate only typical embodiments of this application and are therefore not to be considered limiting of its scope, for the application may admit to other equally effective embodiments.

These and other features, benefits, and advantages of the present application will become apparent by reference to the following text Figure, with like reference numbers referring to like structures across the views, wherein:

FIG. 1A illustrates a computer implemented business management system for an organization, in accordance with an embodiment of the present invention

FIG. 1B illustrates a business management platform of the system of FIG. 1A, in accordance with an embodiment of the present invention:

FIG. 1C illustrates a business management platform of the system of FIG. 1A, in accordance with an embodiment of the present invention:

FIG. 2A illustrates a computer implemented business management method for an organization, in accordance with an embodiment of the present invention:

FIG. 2B illustrates a method of operation of the performance management module, in accordance with an embodiment of the present invention; and

FIGS. 3A-3G illustrate screenshots of different aspects of the performance management module covered in FIG. 2B, in accordance with another embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including.” “comprising.” “having.” “containing.” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of”, “including”, or “is” preceding the recitation of the composition, element or group of elements and vice versa.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art.

In a brief explanation, an embodiment of the present invention may be understood as a computer implemented business management system and method for an organization. It is designed to is to help businesses grow by making sure that all parts of the business organization are working efficiently. The embodiment of the present invention is based on the fact that everything in business starts first and foremost with making sure that Goals are clearly identified for all of the disciplines. These Goals may be related to the Product/Service, Market, or Operations of the organization. This is followed by creating Plans, Strategies, and Action Items that specify what needs to be executed, what resources are needed, the measure of success, the time to achieve these, and the reward/recognition for successful execution. Ultimately, the ability to streamline everything in the organization from its Goals down to its Plans, Strategies, and Action Items while addressing the main challenges that businesses face i.e., Executive Alignment, Operational Execution, Accountability, and Driving Motivation.

Accordingly, the embodiment of the present invention assimilates and visualizes information from the main modules (Key-Result-Areas) of the business management platform containing different data sources of Sales (CRM System), Marketing (Marketing Automation and Campaign Management), Customer Engagement (Customer Support and Management System), and People Development (Learning Management System) teams. As a result, the presented solution acts as a driver and enabler of teams and individuals, by allowing the organizations to easily manage, track, align and reward their Sales, Marketing, Customer Engagement, and Personnel Development Teams in one Integrated Platform.

For better understanding of different aspects of the embodiments of the invention, the present invention will now be described in detail with reference to accompanying drawings.

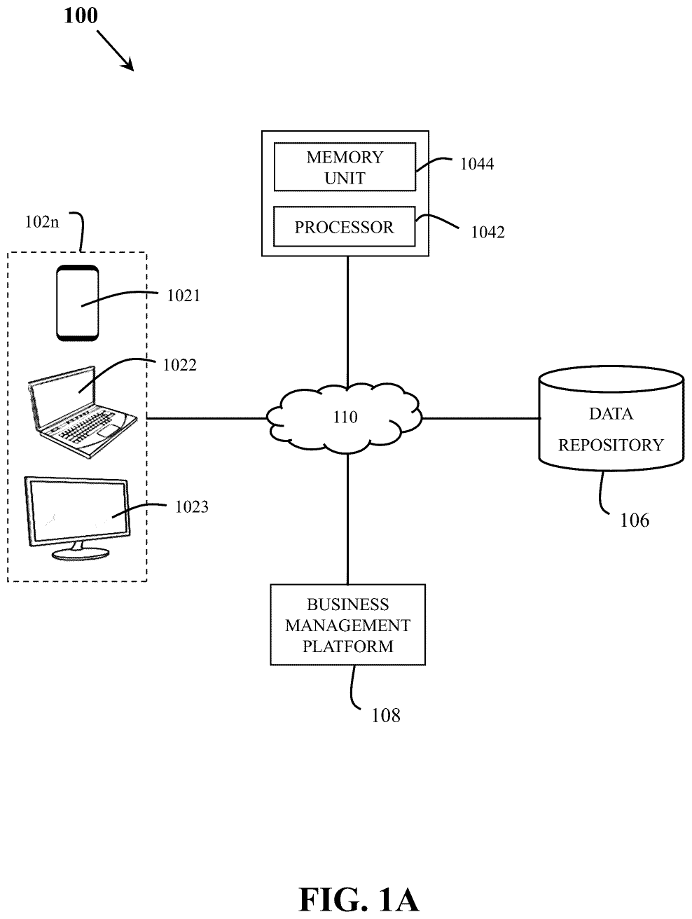

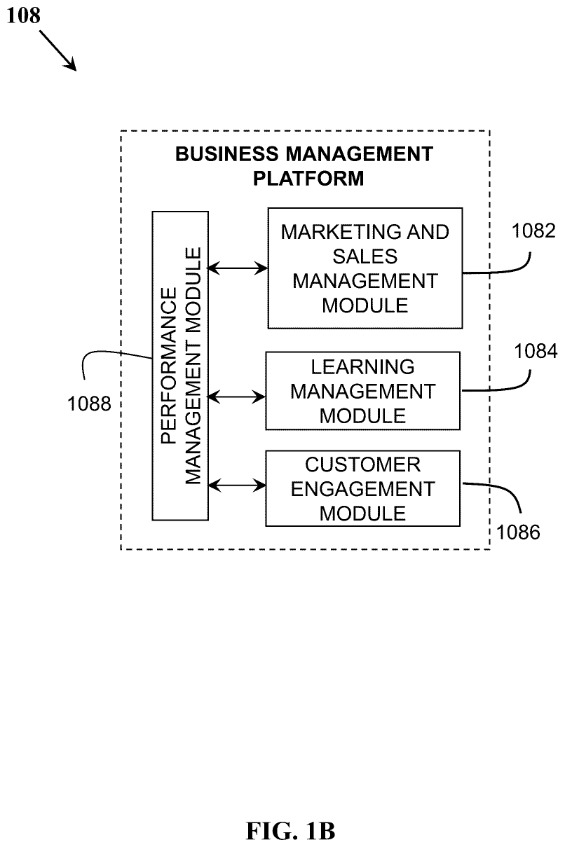

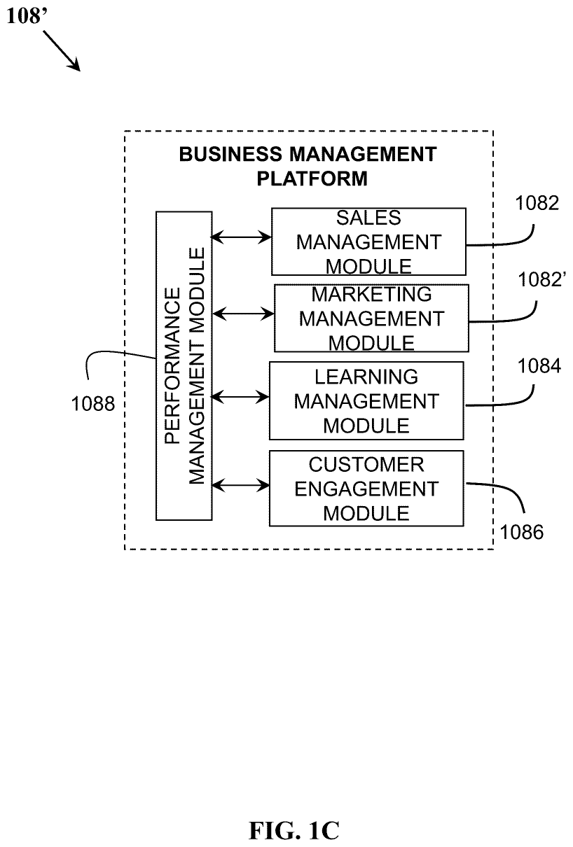

FIG. 1A illustrates a block diagram that describes a computer implemented business management system for an organization, in accordance with an embodiment of the present invention. As shown in FIG. 1, the computer implemented business management system 100 (hereinafter referred to “the system” 100) may include, but not limited to, at least a processor 1042, a memory unit 1044, a business management platform 108, and a plurality of network-connected computer user interfaces 102 for a plurality of participants. In alternative configurations, different and/or additional modules can be included in the system 100.

The system 100 is envisaged to include computing capabilities such as a memory unit 1044 configured to store machine readable instructions. The machine-readable instructions may be loaded into the memory unit 1044 from a non-transitory machine-readable medium, such as, but not limited to, CD-ROMs, DVD-ROMs, Flash drives, clouds or servers. Alternatively, the machine-readable instructions may be loaded in the form of a computer software program into the memory unit 1044. The memory unit 1044 in that manner may be selected from a group comprising EPROM, EEPROM and Flash memory. Furthermore, the system 100 includes the processor 1042 operably connected with the memory unit 1042. In various embodiments, the processor 1042 may be one of, but not limited to, microprocessor, a general-purpose processor, an application specific integrated circuit (ASIC) and a field-programmable gate array (FPGA). In one embodiment, the processor 104 may be part of a server (such as local or a remote server). In some embodiments, the memory unit and the processor are part of a computer system. Moreover, the processor 1042 may also implement artificial intelligence and machine learning based technologies for, but not limited to, data analysis, collating data & presentation of data in real-time.

Furthermore, as shown in FIG. 1A, the system 100 includes a communication network 110 to the processor 1042 and the memory unit 1044 are connected. The communication network 110 can be a short-range communication network and/or a long-range communication network, wire or wireless communication network. This may involve a communication interface such as, but not limited to, a serial communication interface, a parallel communication interface or a combination thereof. The communication network 110 may be implemented using a number of protocols, such as but not limited to, TCP/IP, 3GPP, 3GPP2, LTE, IEEE 802.x etc. Preferably, the communication network 110 is internet.

Additionally connected with communication network 110 are the plurality of computer user interfaces (of network-connected) 102 associated with the plurality of participants. Herein, the plurality of participants may include, but not limited to, owners (or Top Management), a plurality of actual or potential team members (divided into teams such as marketing, sales, accounts etc.), respective team managers (such as sales manager, business unit managers, P/L managers, LOB Manager etc.) and customers/clients.

In that sense, the plurality of computer user interfaces 102 may be understood as one or more computing devices that can receive input, can display information, and can transmit as well as receive data via the communication network 110. For example, the plurality of computer user interfaces 102 may be desktop computers, laptop computers, smart phones, personal digital assistants (PDAs), or any other device including computing functionality and data communication capabilities. The plurality of computer user interfaces 102 are configured to communicate via the communication network 110, which may comprise any combination of local area and/or wide area networks, using both wired and wireless communication systems (as already explained above). The plurality of computer user interfaces 102 may be running a web browser or an installed device application, that allows the respective participant at the respective device to view web pages/content served by the business management platform 108 100. These plurality of participants may be registered members of the business management platform 108 and may be provided with the respective individual and/or team profile.

Additionally, as shown in FIG. 1A, the system 100 comprises the business management platform 108 which may be managed by the administrator (support team). In general, there are business management platforms can be understood as tools, applications, controls, calculating solutions, methodologies, etc. used by organizations to be able to cope with changing markets, ensure a competitive position in them and improve business performance. However, these tools are generally related to a particular aspect of management in each organization's department, for example, Strategic planning, Customer relationship management, Employee engagement, Benchmarking, Balanced scorecard etc. So, this makes it tedious and difficult to so many different system/tools for all business/organizational needs and their independent operation sometimes have an adverse effect on the efficiency. The embodiment of the present invention therefore provides an integrated all-in-one solution for managing different aspects of the organization. It may be provided in a form of a mobile or a PC-based application capable of running on Android, IOS, Windows, MacOS etc. and/or in as a website/web-based tool capable of running on web browsers.

FIG. 1B illustrates a business management platform 108 of the system 100 of FIG. 1A, in accordance with an embodiment of the present invention. Herein, the business management platform 108 comprises, but not limited to, a marketing and sales management module 1082, a learning management module 1084, a customer engagement module 1086, and a performance management module 1088. The performance management module 1088 is integrated with the marketing and sales management module 1082, the learning management module 1084, and the customer engagement module 1086. In accordance with an embodiment of the present invention, the business management platform 108 may further include a role management module, a team management module, a tasks management module, a notes management module, a calendar management module, an email management module and a communications management module, to complement and provide additional features.

In accordance with an embodiment of the present invention, the word “module,” as used herein, refers to logic embodied in hardware or firmware, or to a collection of software instructions, written in a programming language, such as, for example, JavaScript, Python R, C. C#, Java, or Assembly. The modules described herein may be implemented as either software and/or hardware modules and may be stored in any type of computer-readable medium or other computer storage device.

In accordance with an embodiment of the present invention, the system 100 may also include a data repository 106. The data repository 106 may be a local storage, a cloud-based storage (centralized network storage) or blockchain storage (decentralized infrastructure). In any manner, the data repository 106 is envisaged to be capable of providing the data to the processor 1042, when the data is queried appropriately using applicable processing, security and other data transfer protocols.

FIG. 1C illustrates a business management platform 108′ of the system 100 of FIG. 1A, in accordance with an embodiment of the present invention. Herein, the business management platform 108′ comprises, but not limited to, a sales management module 1082, a marketing management module 1082′, a learning management module 1084, a customer engagement module 1086, and a performance management module 1088. The performance management module 1088 is integrated with the sales management module 1082, the marketing management module 1082′, the learning management module 1084, and the customer engagement module 1086. In accordance with an embodiment of the present invention, the business management platform 108′ may further include a role management module, a team management module, a tasks management module, a notes management module, a calendar management module, an email management module and a communications management module, to complement and provide additional features.

In accordance with an embodiment of the present invention, the various modules of the business management platform 108′ creates a framework for which integrates various aspects impacting business growth such as Sales, Marketing, Accountability, Retention and Training. In accordance with an embodiment of the present invention, the framework may be termed as S.M.A.R.T resembling one platform weaving each of the aspects with each other to support wholistic growth of a business.

In accordance with an embodiment of the present invention, the word “module,” as used herein, refers to logic embodied in hardware or firmware, or to a collection of software instructions, written in a programming language, such as, for example, JavaScript, Python R, C, C#, Java, or Assembly. The modules described herein may be implemented as either software and/or hardware modules and may be stored in any type of computer-readable medium or other computer storage device.

In accordance with an embodiment of the present invention, the system 100 may also include a data repository 106. The data repository 106 may be a local storage, a cloud-based storage (centralized network storage) or blockchain storage (decentralized infrastructure). In any manner, the data repository 106 is envisaged to be capable of providing the data to the processor 1042, when the data is queried appropriately using applicable processing, security and other data transfer protocols.

### Method 200 of Operation:

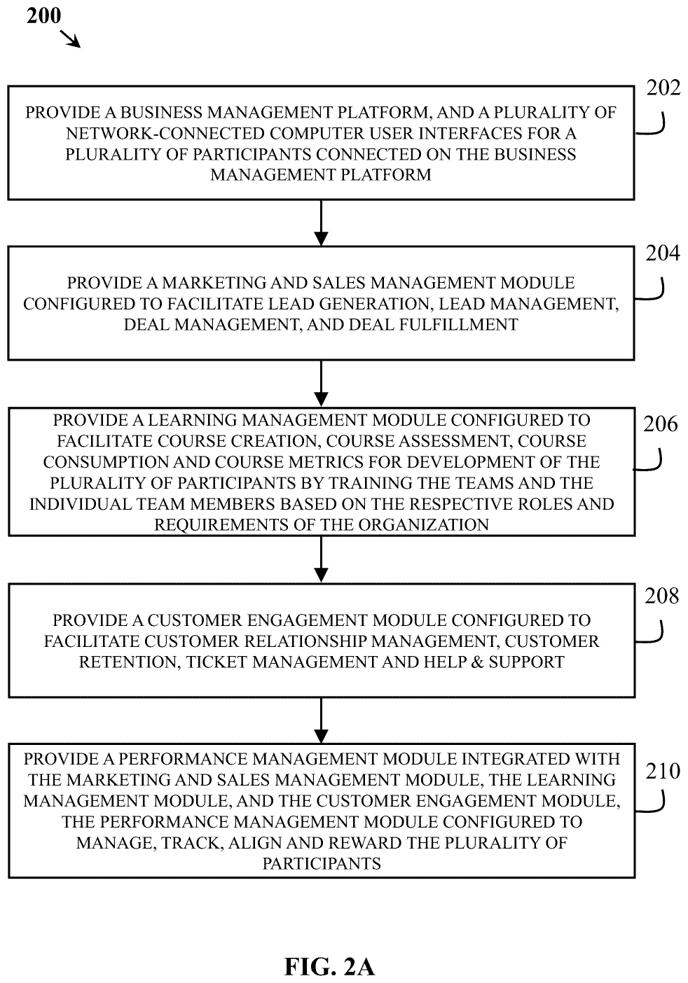

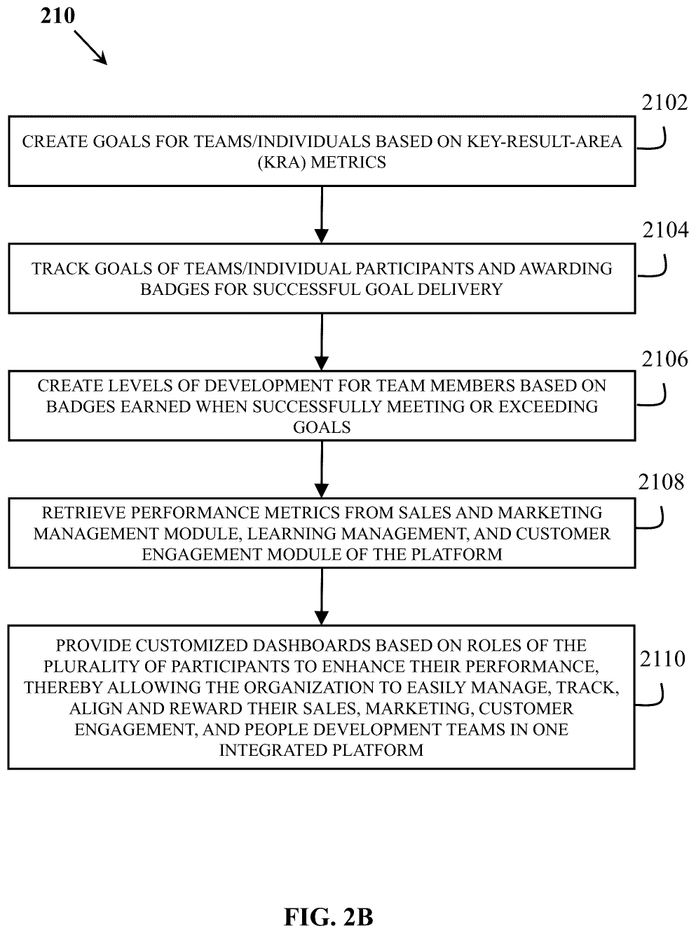

FIG. 2A illustrates a computer implemented business management method 200 for an organization, in accordance with an embodiment of the present invention. The computer implemented business management method 200 (herein after referred to as “the method 200”) starts at step 202, by providing the business management platform 108, and the plurality of network-connected computer user interfaces for a plurality of participants connected on the business management platform 108. The business management platform 108 is provided with, but not limited to, a marketing and sales management module 1082, a learning management module 1084, a customer engagement module 1086, and a performance management. It should be noted that the hardware and system-related information has been provided in detail above, so the same may not have been repeated in this section for the sake of brevity.

Next at step 204, the marketing and sales management module 1082 is configured to facilitate functions such as, but not limited to, lead generation, lead management, deal management, and deal fulfillment. These may include, but not limited to, the following features:

### Lead/Contact Generation, Qualification, and Management

Import leads/contacts from third party/CSV/Spreadsheet.
Call/SMS, Email Leads/Contacts worldwide directly from the list.
Integrate your email and create campaigns w/built-in analytics.
Integrate WhatsApp, Line, Viber.
Track/Log all communications.
On-the-fly tagging of leads/contacts for faster searching, filtering, and sorting.

### Deal Management

Information-a-glance User Interface.
Deal tracking and automatic relationship of Accounts, Contacts, Tasks, Calls, Meetings, To-do's, Quotes, Invoices
Automatic reminder/notification of important Deal events (Eg. Deal Close Date.).
Direct interface to a full-suite Inventory, Quote, and Invoice Management system 100.

### Deal/Opportunity Fulfillment

Payment and delivery status tracking.

Additionally, the marketing and sales management module 1082 is integrated with the Performance management module 1088, which in combination enables the following features in the business management platform 108:
Manage, track, align, and reward marketing/sales goals.
Visualize sales and marketing data in our dashboards.
Built-in Gamification features.

This helps the marketing and sales team to achieve/gain qualified leads, shorter sales cycle, less revenue operations overhead, world-class quality, on-time delivery, and more importantly high customer satisfaction.

After that, at step 206, the learning management module 1084 is configured to facilitate functionalities such as, but not limited to, course creation, course assessment, course Consumption and course metrics for development of the plurality of participants by training the teams and the individual team members based on the respective roles and requirements of the organization. These may include, but not limited to, the following features:

### Course Management

Create your own training programs based on topics important to your company.
Assign courses to teams/individuals.
   Individuals.
   Teams/Organizations.
   Roles.
Insert interactive questions (cannot be skipped) within your training video.
   True or False.
   Multiple Choice.
   Fill in the Blanks.
Create assessment/exam at the end of every course.
   Define passing score.
Create assessment/exam in our learning management system 100 from courses taken from other platforms.
Issue customizable certificates for every course completed.
Earn badges for every course completed.
Built-in Gamification features.

Additionally, the learning management module 1084 is integrated with the Performance management module 1088, which in combination enables the following features in the business management platform 108:
Create and manage training goals.
   Course Consumption Metrics
   Started
   In-Progress
   Completed
Visualize training data in our dashboards.
   Widget-Type, customized dashboards based on Role.

For example: the business management platform 108 may provide a dedicated training center wherein the respective participant (team member) can access courses and learn about skills such as, but not limited to, B2B sales, B2B marketing, Onboarding-Corp, Onboarding-Team, Sales strategies, Elevator pitches. These courses may have an assessment test at the end with predetermined passing score. Once cleared, the participant may be provided with badges, points, etc. to their respective profile. These helps elevate operational efficiency of the participants (employees) who can then enhance their skills and working profile.

In accordance with an embodiment of the present invention, the learning management module 1084 may be further configured to facilitate psychometric assessments of a plurality of actual or potential team members, and respective team managers (say, employees) to assess the respective intelligence, abilities, potential and personality. Accordingly, a best possible team and work profile may be suggested to the employee so as to help them realize their full potential.

Then, at step 208, the customer engagement module 1086 is configured to facilitate functions such as, but not limited to, customer relationship management, customer retention, ticket management and help & support. These may include, but not limited to, the following features:

### Ticket Management

Create tickets from phone, chat, email, and social media.
   Centralize your ticket management process.
Information-at-a-glance User Interface.
Custom ticket properties and pick lists.
Ticket and support activity history/logs.
Integrated to Communication Solutions of the platform.
   Allows for live Calls and SMS.
   Web Chat.
   Support your customers via integrated social media apps WhatsApp, Line, Viber.
Fully integrated to our Sales and Marketing 360 Solution.
   Allows for better customer/account management.
Fully integrated to our Common Features.
   Automatic Routing and Escalation.

Additionally, the customer engagement module 1086 is integrated with the Performance management module 1088, which in combination enables the following features in the business management platform 108:
Create and manage customer success goals.
   Customer Success Metrics
   Tickets Resolved
   Resolution Time
   Customer Score (Quality of Service)
   A lot more
Visualize customer success data in our dashboards.
   Widget-Type, customized dashboards based on Role.

For example: the business management platform 108 may provide customer engagement window, where the participant (employee) is able to see the list of all queries/tickets raised by the customers along with the details of the ticket/customer, priority level as well as the current status of the matter. To know more about a particular query/ticket, the employee can open that ticket in a separate window to get complete information (such as date of creation, handler, record ID, source etc.) of the same. These helps ensure advocacy of the customer, and consequently increase the chances of repeat orders, that ultimately builds customer loyalty and accelerates growth.

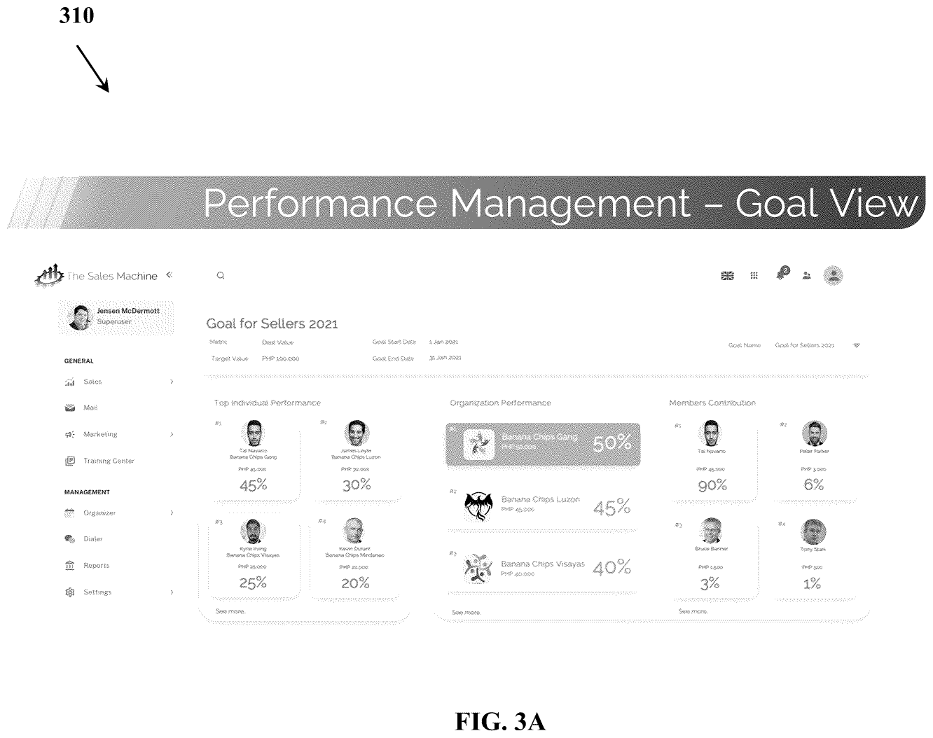

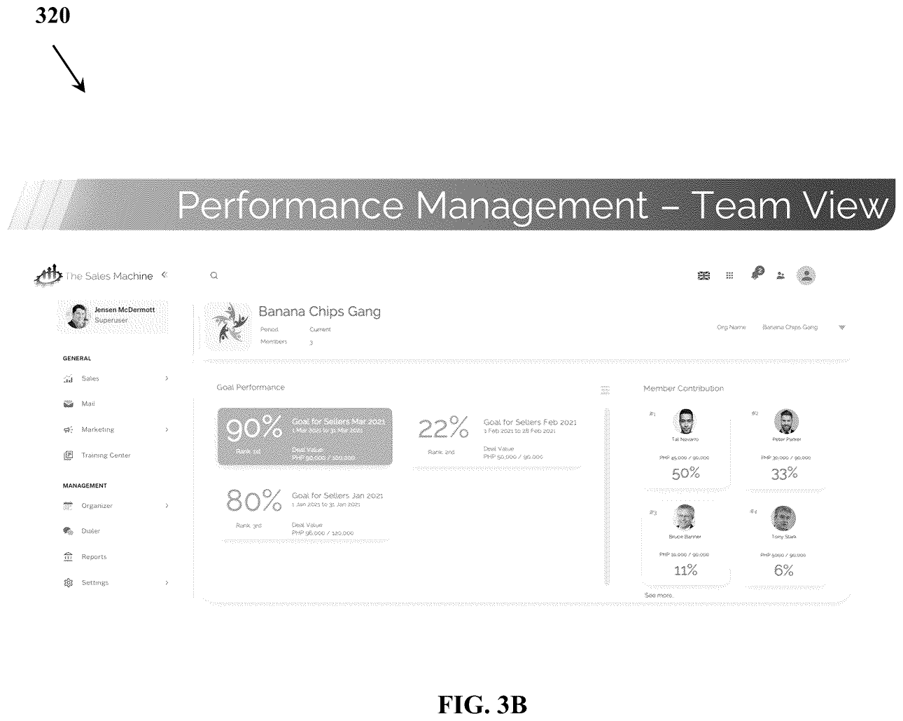

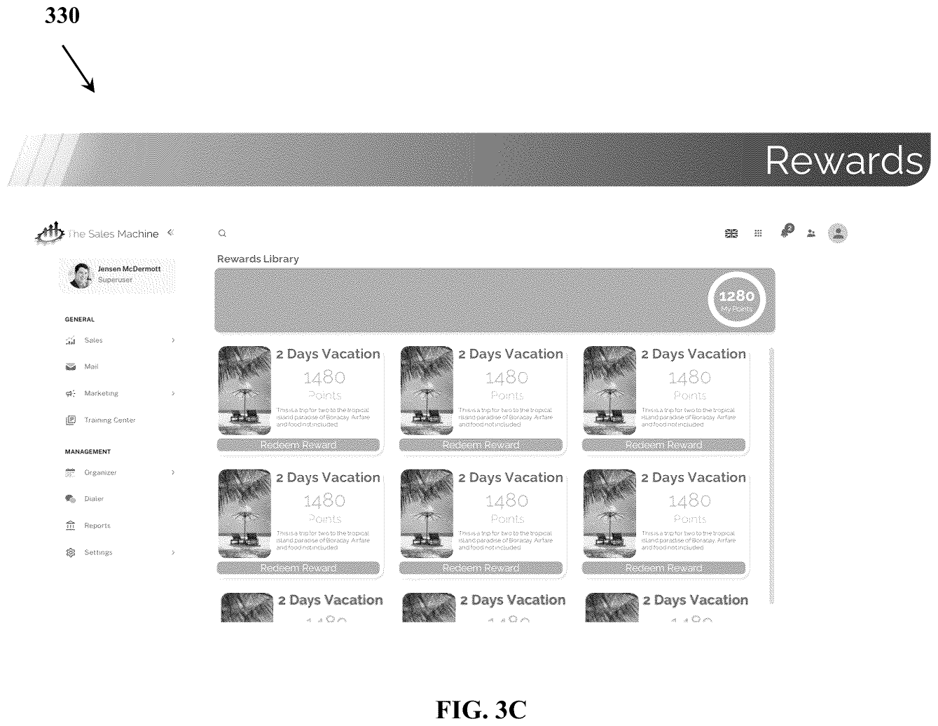

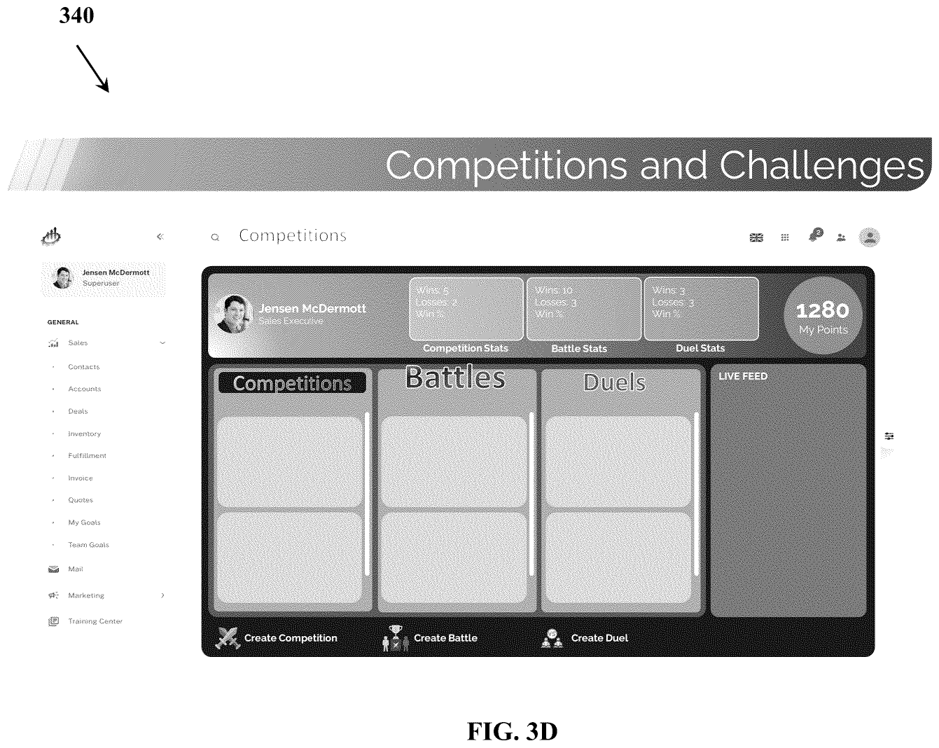

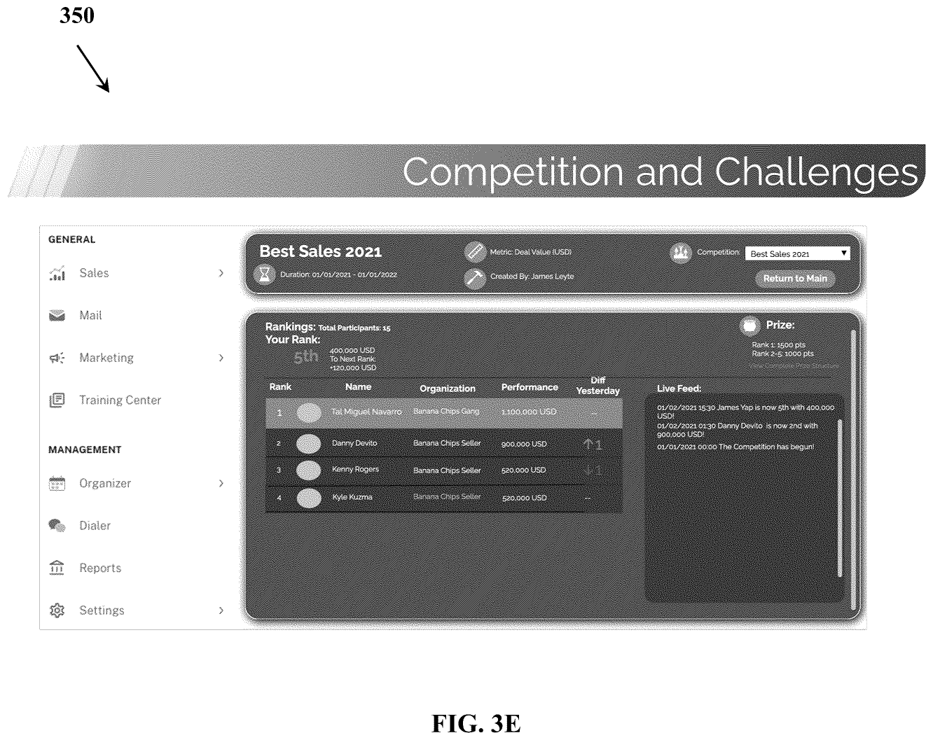

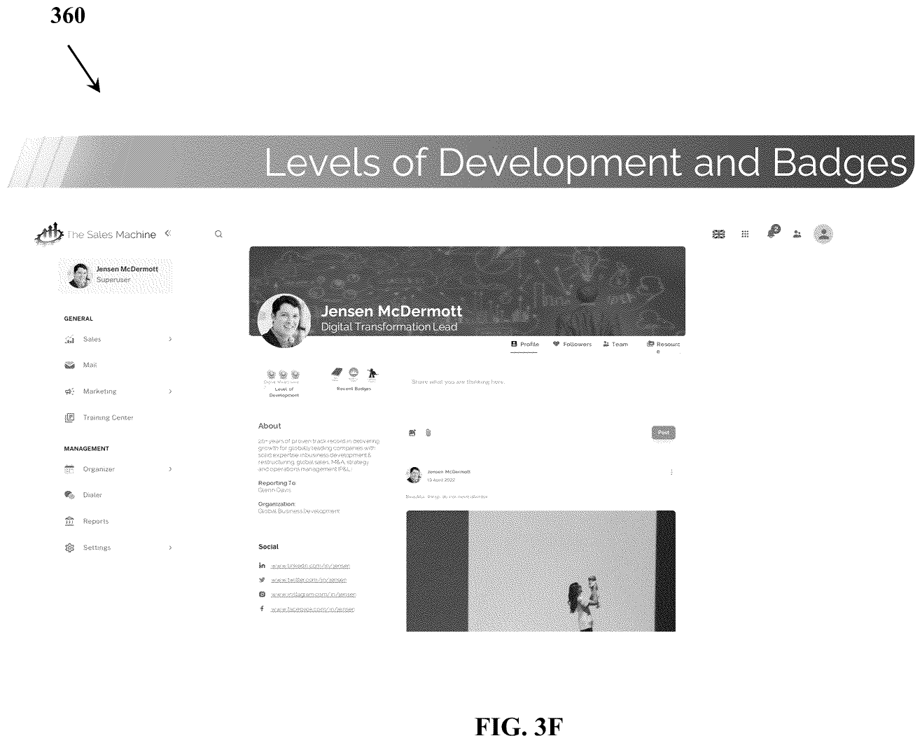

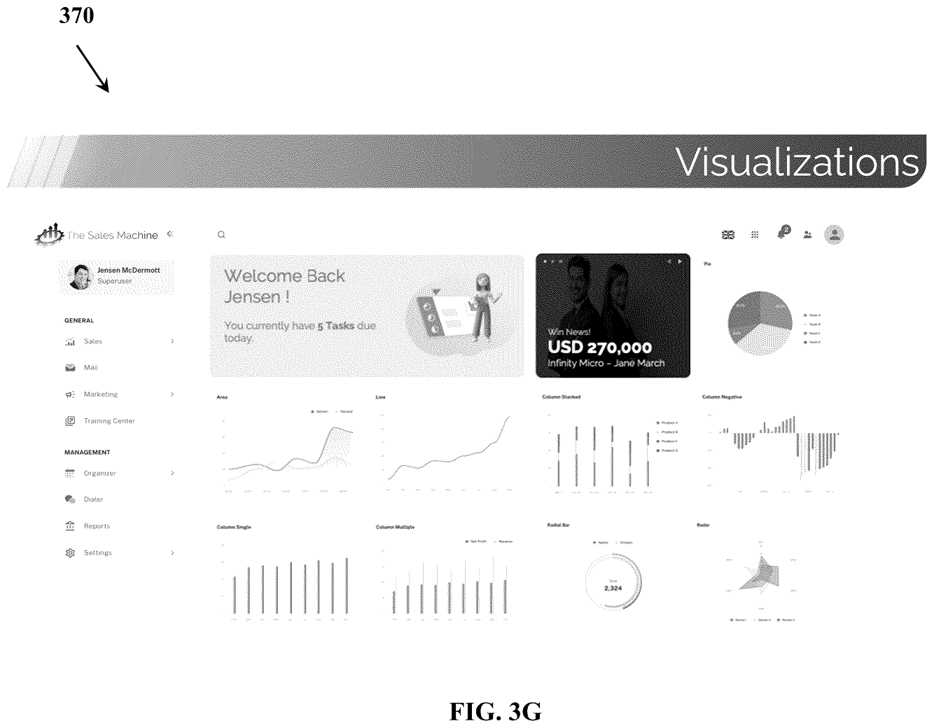

Furthermore, at step 210, the performance management module 1088 is configured to manage, track, align and reward the plurality of participants. FIG. 2B illustrates a method 200 of operation of the performance management module 1088 to facilitate the above, in accordance with an embodiment of the present invention. Besides, this will be better understood in reference to FIGS. 3A-3G which illustrate screenshots of different aspects of the performance management module 1088 covered in FIG. 2B, in accordance with another embodiment of the present invention.

As shown in FIG. 1, at the step 2102, the performance management module 1088 is configured to create goals for teams/individuals based on Key-Result-Area (KRA) metrics. KRA's may be understood as a part of the organization that has a significant impact in the company's growth strategy. These goals may be selected from, but not limited to:
A no. of Deals Closed
A no. of Leads Created
Leads Converted (to Customer)
Successful Calls
Tasks Completed
SMS/Emails Sent
Marketing Campaign Performance

Then, step 2104 involves tracking goals of teams/individual participants and awarding badges for successful goal delivery. This includes providing automatic leaderboards where team member and managers can see the best performers, and comparing metric results of teams/individuals. The same has been shown in FIGS. 3A and 3B. Herein, the top individual performances can be seen in FIG. 3A and the top performances have been shown in FIG. 3B.

Accordingly, the participants are awarded for successful goal delivery. For example: Teams/Individuals can earn points and convert these to company rewards as shown in FIG. 3C. As can be seen from the FIG. 3C, the business management platform 108 further comprises a reward library. Herein, in the present example, the participant is being offered a two-day vacation in exchange for 1480 points. In another example, other rewards such as discount coupons for e-commerce or movie tickets etc. can be rewarded as well. Such rewards and incentives (apart from their monthly salaries) encourage Teams/Individuals to give extra effort and push them to perform better. Also, the employees also feel valued and respected when their name shown up on the leaderboard in good performers with one or more award badges.

Furthermore, many built-in gamification features may be provided to promote competition with individuals and teams by means of games. For example, as shown in FIG. 3D, the various battles and duels can be arranged between members of the same teams or between teams based on a certain predetermined goal, such as most sales, most leads etc., and after completion, the winner gets a predetermined no. of points. FIG. 3E shows a results page where the top performers of the competitions are shown.

Next, step 2106 involves creating levels of development for team members based on badges earned when successfully meeting or exceeding goals. It is extremely important for team member to feel valued especially the ones who are consistent meeting the target and also the ones who are overachieving. For example, if a participant may have earned multiple badges in competitions and has been consistently meeting his/her targets, so this information is always displayed in the participant's profile. There may be a level of development provided within a team or an organization, say, on a scale of 1 to 10. So, the participants may be promoted up the levels as they consistently put up good performances and these achievements are transparently visible on their profiles as well.

After that, at step 2108, the performance management module 1088 is configured to retrieve performance metrics from Sales and Marketing management module, Learning Management, and Customer engagement module 1086 of the platform; and at step 2110, the same are provided in the customized dashboards based on roles of the plurality of participants to enhance their performance. Since the embodiment of the present invention provides an integrated solution for all the modules, therefore, the data regarding the sales, marketing, learning (courses completed) and customers engagement (such as queries resolved), is gathered by the processor. This data is then processed to provide all the information in the respective team member's dashboard and the team manager. It may be provided in the form of data metrics or in a form of visualizations (as shown in FIG. 3G) as desired by the team member or the team manager, to help the respective participants understand their present position and progress in an easy manner. This allows the organization to easily manage, track, align and reward their sales, marketing, customer engagement, and people development teams in one Integrated Platform.

In accordance with an embodiment of the present invention, the KRA's may have to be reassessed and readjusted from time to time to bring in more challenges and more rewards, while upskilling the team members.

Furthermore, embodiments of the present invention offer several advantages. Firstly, an embodiment of the present invention provides a one-stop solution for all the business management needs of an organization. The system and method disclosed herein eliminate the requirement of switching between various different platforms and tools to manage multiple needs of an organization, thereby saving both the time and money, while increasing employee efficiency and motivation. Additionally, an embodiment of the present invention enables the Sales, Marketing, Customer Engagement, and People Development teams to:
Reach more prospects.
Convert more leads.
Close more deals.
Increase profit margins.
Provide excellent customer service.
Get clients to advocate products/services.
Identify what's working and what's not working.
Identify needed resources.
Elevate team members.
Reward team members.
Replicate success.
   Therefore, the embodiment of the present invention offers a one-stop solution for businesses all around the world helping organizations Grow by Increasing Sales, Maximizing Profitability, Elevating Teams, and Delivering Exceptional Customer Service.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Additionally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope consistent with the principles and the novel and inventive features disclosed or suggested herein. Accordingly, the application is anticipated to hold on to all other such alternatives, modifications, and variations that fall within the scope of the present application and the appended claims.

1. A computer implemented business management system for an organization, the system comprising at least a processor, a memory unit, a business management platform, and a plurality of network-connected computer user interfaces for a plurality of participants, said participants comprising owners, a plurality of actual or potential team members, respective team managers and customers, wherein the business management platform comprising:
a marketing and sales management module configured to facilitate lead generation, lead management, deal management, and deal fulfillment;
a learning management module configured to facilitate course creation, course Assessment, course Consumption and course metrics for development of the plurality of participants by training the teams and the individual team members based on the respective roles and requirements of the organization;
a customer engagement module configured to facilitate customer relationship management, customer retention, ticket management and help & support;
a performance management module integrated with the marketing and sales management module, the learning management module, and the customer engagement module, the performance management module configured to manage, track, align and reward the plurality of participants, by:
creating goals for teams/individuals based on Key-Result-Area (KRA) metrics;
tracking goals of teams/individual participants and awarding badges for successful goal delivery;
creating levels of development for team members based on badges earned when successfully meeting or exceeding goals;
retrieving performance metrics from Sales and Marketing management module, Learning Management, and Customer Engagement module of the platform; and
providing customized dashboards based on roles of the plurality of participants to enhance their performance, thereby allowing the organization to easily manage, track, align and reward their sales, marketing, customer engagement, and people development teams in one Integrated Platform.

2. The system as claimed in claim 1, wherein the lead generation and lead management includes importing leads/contacts from third party and spreadsheets, enabling Call/SMS, Email Leads/Contacts worldwide directly from the list, integrating the email and creating campaigns with built-in analytics, integrating messaging apps, tracking and logging all communications, and on-the-fly tagging of leads/contacts for faster searching, filtering, and sorting.

3. The system as claimed in claim 1, wherein the deal management includes deal tracking and automatic relationship of Accounts, Contacts, Tasks, Calls, Meetings, To-do's, Quotes, invoices, automatic reminder/notification of important Deal events, provide a direct interface to a full-suite Inventory, Quote, and an Invoice Management system.

4. The system as claimed in claim 1, wherein the course management includes creating training programs based on topics important to the organization, assigning courses to teams/individual participants, providing interactive training multimedia content, creating assessment tests at the end of a training program, and issuing certificates and/or badges for the completed training programs or courses.

5. The system as claimed in claim 1, wherein the ticket management includes providing an information-at-a-glance user interface that allows to create tickets from phone, chat, email, and social media, shows custom ticket properties and pick lists, shows ticket and support activity history/logs and is also integrated to Communication Solutions and the marketing & sales module of the platform.

6. The system as claimed in claim 1, wherein the learning management module is further configured to facilitate psychometric assessments of a plurality of actual or potential team members, and respective team managers to assess the respective intelligence, abilities, potential and personality.

7. The system as claimed in claim 1, wherein the performance management module is further configured to facilitate gamification of the goal creation, tracking, alignment and rewards in a form of challenges, battles and duels to promote competition and growth.

8. The system as claimed in claim 1, wherein the rewards are provided in a form of redeemable reward points, offers or coupons.

9. The system as claimed in claim 1, wherein the business management platform further comprises a role management module, a team management module, a tasks management module, a notes management module, a calendar management module, an email management module and a communications management module.

10. The system as claimed in claim 1, wherein the network-connected computer user interfaces are selected from Desktop PCs, laptops, tablets and mobile phone.

11. A computer implemented business management method for an organization, the method comprising:
providing a business management platform, and a plurality of network-connected computer user interfaces for a plurality of participants connected on the business management platform, said participants comprising owners, a plurality of actual or potential team members, respective team managers and customers;
providing a marketing and sales management module configured to facilitate lead generation, lead management, deal management, and deal fulfillment;
providing a learning management module configured to facilitate course creation, course assessment, course Consumption and course metrics for development of the plurality of participants by training the teams and the individual team members based on the respective roles and requirements of the organization;
providing a customer engagement module configured to facilitate customer relationship management, customer retention, ticket management and help & support; and
providing a performance management module integrated with the marketing and sales management module, the learning management module, and the customer engagement module, the performance management module configured to manage, track, align and reward the plurality of participants, by:
creating goals for teams/individuals based on Key-Result-Area (KRA) metrics;
tracking goals of teams/individual participants and awarding badges for successful goal delivery;
creating levels of development for team members based on badges earned when successfully meeting or exceeding goals;
retrieving performance metrics from Sales and Marketing management module, Learning Management, and Customer Engagement module of the platform; and
providing customized dashboards based on roles of the plurality of participants to enhance their performance, thereby allowing the organization to easily manage, track, align and reward their sales, marketing, customer engagement, and people development teams in one Integrated Platform.

12. The method as claimed in claim 11, wherein the steps of lead generation and lead management in the marketing and sales management module includes importing leads/contacts from third party and spreadsheets, enabling Call/SMS, Email Leads/Contacts worldwide directly from the list, integrating the email and creating campaigns with built-in analytics, integrating messaging apps, tracking and logging all communications, and on-the-fly tagging of leads/contacts for faster searching, filtering, and sorting.

13. The method as claimed in claim 11, wherein the step of the deal management in the marketing and sales management module includes deal tracking and automatic relationship of Accounts, Contacts, Tasks, Calls, Meetings, To-do's, Quotes, invoices, automatic reminder/notification of important Deal events, provide a direct interface to a full-suite Inventory, Quote, and an Invoice Management system.

14. The method as claimed in claim 11, wherein the step of the course management in the learning management module includes creating training programs based on topics important to the organization, assigning courses to teams/individual participants, providing interactive training multimedia content, creating assessment tests at the end of a training program, and issuing certificates and/or badges for the completed training programs or courses.

15. The method as claimed in claim 11, wherein the step of ticket management in the customer engagement module includes providing an information-at-a-glance user interface that allows to create tickets from phone, chat, email, and social media, shows custom ticket properties and pick lists, shows ticket and support activity history/logs and is also integrated to Communication Solutions and the marketing & sales module of the platform.

16. The method as claimed in claim 11, further comprising a step of gamification of the goal creation, tracking, alignment and rewards in a form of challenges, battles and duels to promote competition and growth.

17. The method as claimed in claim 11, further comprising a step of conducting psychometric assessments of a plurality of actual or potential team members, and respective team managers to assess the respective intelligence, abilities, potential and personality.

18. The method as claimed in claim 11, wherein the rewards are provided in a form of redeemable reward points, offers or coupons.

19. The method as claimed in claim 11, further comprising steps of providing a role management module, a team management module, a tasks management module, a notes management module, a calendar management module, an email management module and a communications management module in the business management platform.

20. The method as claimed in claim 11, wherein the network-connected computer user interfaces are selected from Desktop PCs, laptops, tablets and mobile phone.
